(19) United States
(12) Patent Application Publication
(10) Pub. No.: US 2017/0040863 A1
(43) Pub. Date: Feb. 9, 2017

(54) HOUSING FOR A DRIVING UNIT FOR A VEHICLE, DRIVING UNIT FOR A VEHICLE AND METHOD FOR PRODUCING A DRIVING UNIT FOR A VEHICLE

(71) Applicant: ZF Friedrichshafen AG, FRIEDRICHSHAFEN (DE)

(72) Inventor: Kurt MICHEL, Pegnitz (DE)

(73) Assignee: ZF Friedrichshafen AG, FRIEDRICHSHAFEN (DE)

(21) Appl. No.: 15/226,265

(22) Filed: Aug. 2, 2016

(30) Foreign Application Priority Data
Aug. 3, 2015 (DE) 10 2015 214 770.3

(51) Int. Cl. H02K 5/20; H02K 15/14; H02K 11/33; B60K 1/00; H02K 5/22

(52) U.S. Cl. CPC H02K 5/20; B60K 1/00; H02K 5/225; H02K 11/33; H02K 15/14; B60K 2001/006; B60Y 2410/12

(57) ABSTRACT

A housing for a drive unit is presented for a vehicle. Here the housing features a first housing segment for accommodating an electric machine and a second housing segment for accommodating a power electronics unit for the electric machine. Here the first housing segment and the second housing segment are shaped in one piece. Here the first housing segment and the second housing segment are configured to run a common cooling circuit for cooling the electric machine and to the power electronics unit.

### BACKGROUND

1. Technical Field

The present invention relates to a housing for a drive unit for a vehicle, to a drive unit for a vehicle, to a vehicle having such a drive unit and a method of manufacturing a drive unit for a vehicle.

2. Background Information

In particular for use in vehicles, a power electronics unit can typically be provided for an electric machine in the form, for example, of an extension-electronics assembly, on or at the electric machine with its own housing.

The DE 10 2013 020 440 A1 displays a connecting element between an integrated starter generator and power electronics assembly.

### BRIEF SUMMARY

Against this background, the present invention provides an improved housing for a drive unit for a vehicle, an improved drive unit for a vehicle to provide an improved vehicle having such a drive unit and an improved method of manufacturing a drive unit for a vehicle according to the main claims. Advantageous embodiments result from the dependent claims and the following description.

A housing for a drive unit for a vehicle features a first housing segment for accommodating an electric machine and a second housing segment for receiving a power electronics unit for the electronic machine, wherein the first housing segment and the second housing segment are formed in one piece, and where the first housing segment and the second housing segment are shaped, in order to run a common cooling circuit for cooling the electric motor and the power electronics unit.

With respect to the vehicle, it can concern simply a road-bound motor vehicle, in particular a passenger car, truck, a utility vehicle or the like. The housing may be formed by using a casting process from a metal or a metal alloy. The housing can in particular be designed as a pressure housing made, for example, from aluminum. With respect to the electric machine, it can in particular consist of a driving machine. The housing may include a guide segment for guiding the common cooling circuit, wherein the guide segment is arranged in the first housing segment and in the second housing segment. The housing may optionally feature at least one further housing segment, which is formed in one piece with or separately and connected to the first housing segment, and additionally or alternatively the second housing segment.

According to embodiments of the present invention, a housing integration of power electronics and an associated electric machine can be realized. An electronics housing base can thereby for example be integrated into a housing of the electric machine and a cooling circuit can be used for common cooling of the electric machine and the electronics.

According to embodiments of the present invention, an independent, separate housing such as an independent, separate cooling circuit for the power electronics can be advantageously be reduced. Cost benefits can be achieved by elimination of parts and a simplification of an assembly. A reduction in parts can be made possible because of a combination of previously separate housings to a housing or part. An existing cooling circuit for an electric machine can thus be used for cooling the power electronics. A simplification of an assembly by reduction of parts can be achieved.

According to one embodiment, the housing may feature at least one passage segment for the passage of coolant in the common cooling circuit between the first housing segment and second housing segment. At least one passage segment can be formed as a penetration, a passage opening, or likewise between the first housing segment and second housing segment. The housing may feature in particular, for example, two or more passage segments, whereby the coolant can pass from the first housing segment into the second housing segment via the first passage segment, and the coolant can pass from the second housing segment into the first housing segment via a second passage segment. Such an embodiment offers the advantage that defined flow characteristics and, additionally or alternatively a defined flow behavior of the coolant can thereby be achieved through the housing segments. A dissipation of heat from both the electric machine and from the power electronics unit can thereby be improved.

The housing may also feature at least one mounting device for mounting the power electronics unit in the second housing segment. The at least one fastening device can in this case be arranged in the second housing segment. The housing may feature moreover at least one contact device for the electrically contacting of one power electronics unit connected to the second housing segment. The second housing segment may be configured to accommodate the power electronics unit in a fixed state and additionally or alternatively in an electrically contacted or electrically contactable state. Such an embodiment offers the advantage that the power electronics in the housing is or can be securely arranged. In addition, an electrical contacting of the power electronics can be simplified.

In particular, the second housing section can be formed in the shape of a hollow, a trough, a well or a cup. Such an embodiment offers the advantage that the power electronics unit can be safely and stably accommodated.

The housing may furthermore feature a lid. The lid may thereby be configured to close off the second housing segment. The lid may be configured to seal off the second housing segment to, in particular, liquids and particles. The lid can be attached to the second housing segment for this purpose. The second housing segment can thereby especially be formed trough-shaped or similarly. For example, the lid may feature at least one mounting device for mounting the power electronics unit in the second housing segment and additionally or alternatively feature at least one contacting device for the electrically contacting of one power electronics unit connected to the second housing segment. Such an embodiment offers the advantage that the power electronics unit can be securely connected and protected against mechanical stress as well as exposure substances.

The lid can be configured here to run a segment of the common cooling circuit. The guide segment may thus also extend into the lid. In one state of the lid mounted on the second housing segment, the common cooling circuit can also be feasible through the lid. The lid can be configured in one piece or several pieces. Such an embodiment offers the advantage that dissipation of heat from the power electronics unit can be improved.

A corresponding drive unit for a vehicle, which comprises an electric machine for the vehicle and a power electronics unit for the electric machine, comprises an embodiment of the housing mentioned above, wherein the electric machine is arranged in the first housing segment and the power electronics unit is arranged in the second housing segment.

In connection with the drive unit, an embodiment of the aforementioned housing can be advantageously used to accommodate the electric machine and the power electronics unit. A corresponding vehicle comprises a gear mechanism and an embodiment of the aforementioned drive unit, which is coupled to the gear mechanism.

An embodiment of the aforementioned drive unit in the vehicle can be advantageously employed or utilized to realize a propulsion of the vehicle.

The vehicle may feature a propulsion system which, for example, may feature at least one electrically powered axle, the electric machine, the gear mechanism and the power electronics unit. Such a drive system can be mounted inexpensively and compactly housed in the vehicle as a result of the drive unit and in particular the housing.

A method for manufacturing a drive unit for a vehicle can be carried out in conjunction with a housing for a drive unit for a vehicle. The housing comprises a first housing segment for receiving an electric machine, and a second housing segment for containing a power electronics unit for the electric machine, whereby the first housing segment and the second housing segment are formed in one piece, and are whereby the first housing segment and the second housing segment are constructed in order to run a common cooling circuit for cooling the electric motor and the power electronics unit. The method comprises a step for arranging the electric machine in the first housing segment and the power electronics unit in the second housing segment.

An embodiment of the aforementioned drive unit can be advantageously produced by carrying out the process for production. The method can also be performed in conjunction with or using an embodiment of the aforementioned housing.

According to one embodiment the method may feature a step of closing off of the second housing segment using a lid. In this case an interior space of the second housing segment can be sealed off in the sealing step with respect to the environment. Such an embodiment offers the advantage that protection of the power electronics unit can be achieved against mechanical and chemical exposure.

### BRIEF DESCRIPTION OF THE DRAWINGS

The invention is illustrated by way of example with reference to the accompanying drawings. Shown are:

FIG. 1 an exploded view of a part segment of a drive unit;

FIG. 2 a perspective view of the drive unit in FIG. 1 in an at least partially assembled state.

FIG. 3 a partial sectional view of the drive unit from FIG. 1 and FIG. 2.

FIG. 4 a schematic representation of a vehicle having a drive unit according to an embodiment of the present invention.

FIG. 5 an exploded view of a part segment of a drive unit according to an embodiment of the present invention.

FIG. 6 a perspective view of the drive unit from FIG. 5, in an at least partially assembled state;

FIG. 7 a partial sectional view of the drive unit from FIG. 5 and FIG. 6; and

FIG. 8 a flow chart of a method for manufacturing according to an embodiment of the present invention.

### DETAILED DESCRIPTION OF THE DRAWINGS AND THE PRESENTLY PREFERRED EMBODIMENTS

In the following description of preferred embodiments of the present invention, for the various figures and similarly acting elements shown, the same or similar reference numerals are used, whereby a repeated description of these elements will be dispensed with.

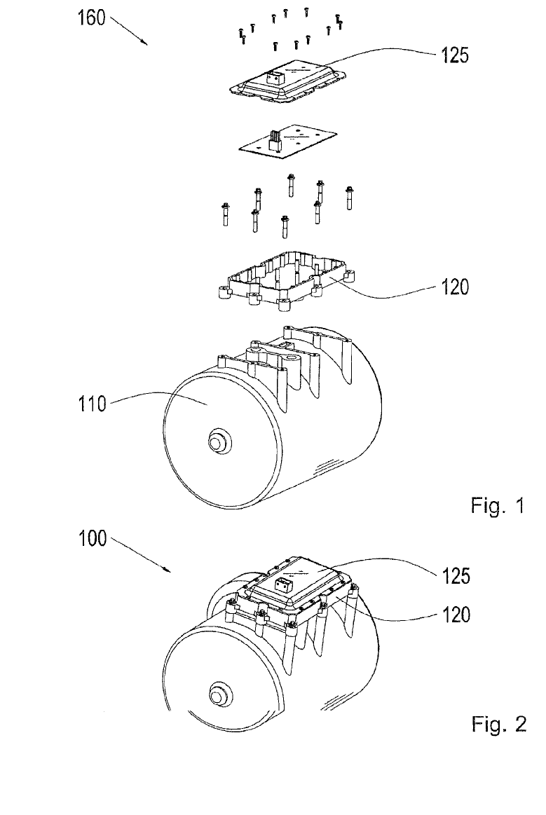

FIG. 1 shows an exploded view of a part segment of a drive unit 100. The drive unit 100 is provided in this case for a vehicle. From the drive unit 100 in the illustration of FIG. 1, a machine housing 110 for an electric machine, an electronics housing 120 for a power electronics unit and a lid 125 are shown.

The machine housing 110 is shaped to accommodate an electric machine. The electronic housing 120 is configured to accommodate the power electronics unit. Here the electronics housing 120 is mountable to the machine housing 110. The lid 120 is configured to cover the electronics housing 120. Thus the lid 120 at the electronics housing 120 is attachable.

In other words, the drive unit 100 has two separate housing parts which are connected to one another.

FIG. 2 shows a perspective view of the drive unit in FIG. 1 in an at least partially assembled state. Here the electronics housing 120 is mounted on the machine housing 110. The lid 125 is also attached to the electronics housing 120.

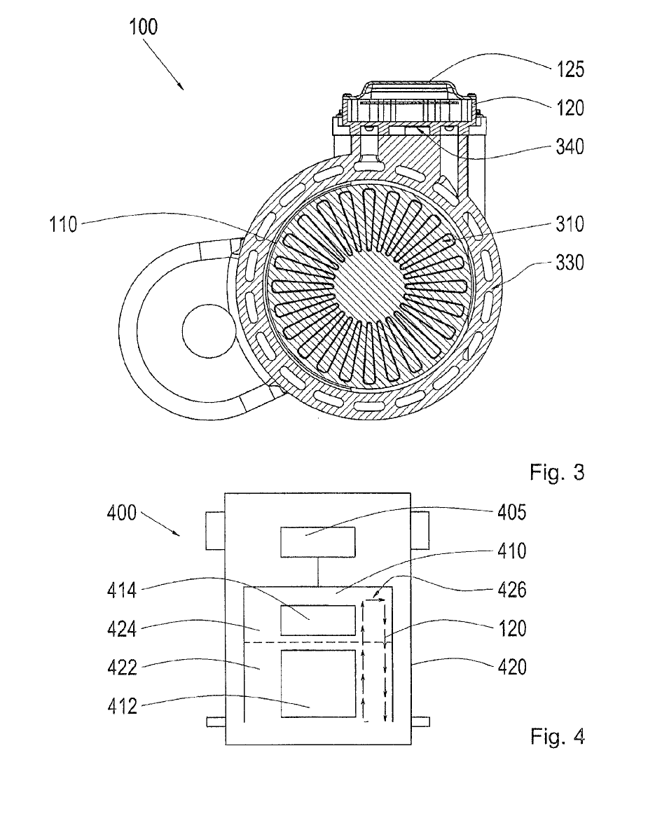

FIG. 3 shows a partial sectional view of the drive unit from FIG. 1 and FIG. 2. Both a part segment of the machine housing 110 and a part segment of the electronics housing 120 with the lid 125 are shown in sections. In the machine housing 110, the electric machine 310 is arranged. Moreover in FIG. 3, a first cooling circuit 330 and a second cooling unit 340 are shown. The first cooling circuit 330 is designed to cool the electric machine 310. Here the first cooling circuit 330 in the machine housing 110. The second cooling circuit 340 is configured to cool a power electronics unit in the electronics housing 120. Here the second cooling circuit 340 runs in the electronics housing 120.

In other words, the drive unit 100 features two separate cooling circuits 330 and 340.

FIG. 4 shows a schematic representation of a vehicle 400 with a drive unit according to an embodiment of the present invention. In the case of the vehicle 400 it concerns a motor vehicle. The vehicle 400 features a gear mechanism 405 and the drive unit 410. The gear mechanism 405 and the driving unit 410 are coupled together.

According to the embodiment of the present invention shown in FIG. 4, the drive unit 410 features an electric machine 412, a power electronics [device] 414 for the electric machine 412, and a housing 420. In this case, the electric machine 412 and the power electronics unit 414 are arranged in the housing 420. The electric machine 412 is designed as a propulsion machine for the vehicle 400.

The housing 420 is shaped, by means of example, through a casting process from a metal or an alloy of various metals, in particular from or with aluminum. In this instance, the housing 420 can also be referred to as a combined housing 420. The housing 420 of the drive unit 410 has a first housing segment 422 and a second housing segment 424. Thereby the first housing segment 422 and second housing segment 424 are shaped in one piece with each other.

The first housing segment 422 is designed to accommodate the electric machine 412. The electric machine 412 is arranged in the first housing segment 422. The second housing segment 424 is designed to accommodate the power electronics unit 414. The power electronics unit 414 is arranged in the second housing segment 424.

Moreover, the first housing segment 422 and the second housing segment 424 are configured to run a common cooling circuit 426 for cooling the electric machine 412 and the power electronics unit 414. For this purpose, the first housing segment 422 and the second housing segment 424 feature at least one guide segment, at least one guide unit or means for guiding, such as pipes, channels or guide walls for accomplishing the common cooling circuit 426.

The drive unit 410 and the housing 420 are in particular described and explained below in more detail.

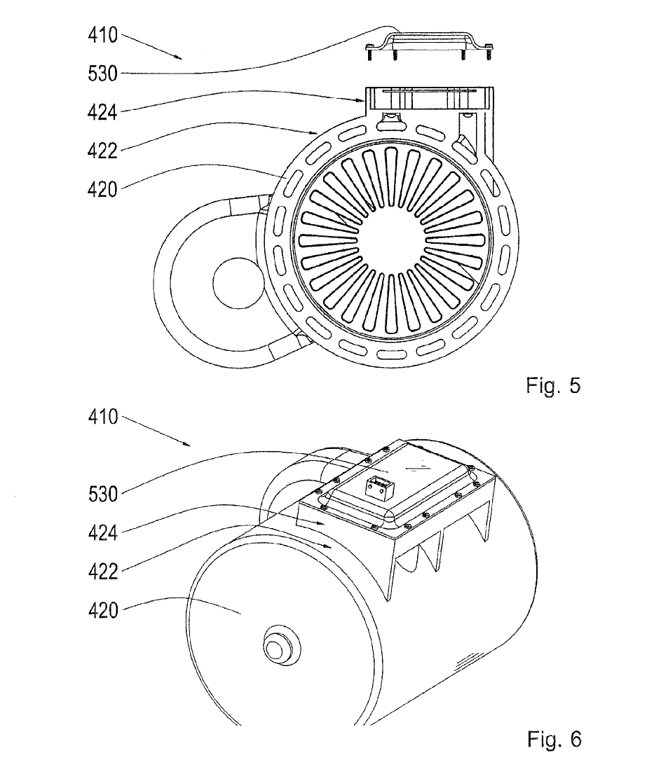

FIG. 5 shows an exploded view of a partial segment of a drive unit 410 according to an embodiment of the present invention. With the drive unit 410 it concerns the drive unit from FIG. 4 or a similar drive unit. The drive unit 410 is intended for a vehicle such as the vehicle from FIG. 4 or a similar vehicle.

In the illustration from FIG. 5 from the drive unit 410, the housing 420 with the first housing segment 422 and the second housing segment 424 are shown according to the embodiment of the present invention illustrated, here along with a lid 530. The lid 530 is shown separately for production reasons in FIG. 5 of the housing 420. In other words, the lid 530 is illustrated prior to mounting on the housing 420.

The lid 530 is configured to seal off the second housing segment 424. The lid 530 on the housing 420 is attachable in order to cover the second housing segment 424. According to the embodiment of the present invention shown in FIG. 5, the second housing section 424 here is in the shape of a hollow, a trough, a well or a cup, even if this is not explicitly visible in FIG. 5 for manufacturing reasons.

In other words, the housing 420 represents the housing segments 422, the housing segments 422 and 424 represent a single-piece, combined or integrated housing, in which a machine housing part and an electronics housing part are integrated or combined.

FIG. 6 shows a perspective representation of a partial segment of the drive unit from FIG. 5 in an at least partially assembled state. The partial segment shown in FIG. 6 substantially corresponds to the partial segment shown in FIG. 5. In the illustration from FIG. 6 are shown from the drive unit 410, the housing 420 with the first housing segment 422 and the second housing segment 424 as well as the lid 530. The lid 530 is here attached or mounted on the housing 420. The lid 530 is thereby mounted to the second housing segment 424 in order to seal an interior space of the second housing segment 424.

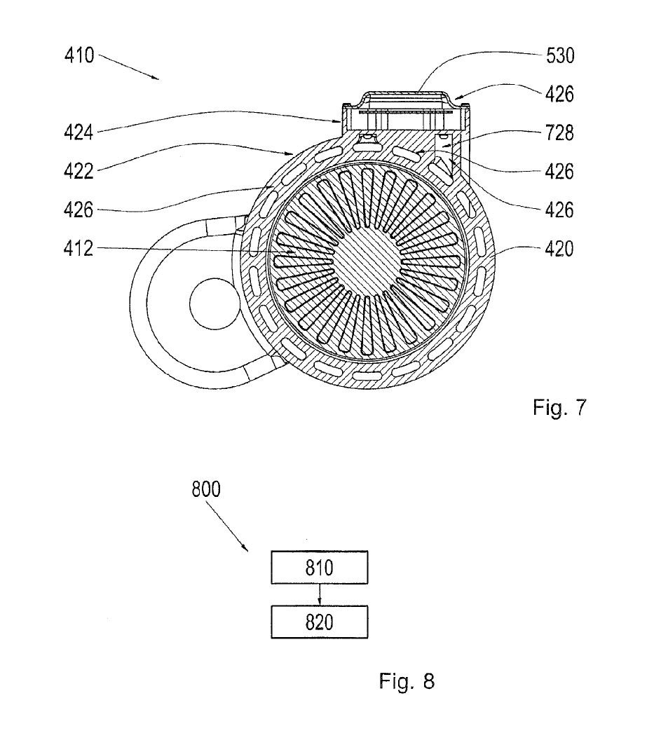

FIG. 7 shows a partial sectional view of a partial segment of the drive unit 410 from FIG. 5 and/or FIG. 6. The partial segment indicated herewith in FIG. 7 corresponds substantially to the partial segment illustrated in FIG. 5 and FIG. 6, with the exception that the view is rotated. The housing 420 of the drive unit 410 is thereby shown in the at least partially assembled state in FIG. 6.

In the illustration from FIG. 7, the electric machine 412, the housing 420 with the first housing segment 422 and the second housing segment 424 and the lid 530 are shown from the drive unit 410. Furthermore, the common cooling circuit 426 as well a passage segment 728, are simply shown by way of example.

Here the electric machine 412 is accommodated or arranged in the first housing segment 422 of the housing 420. The common cooling circuit 426 passes through the first housing segment 422 and the second housing segment 424. According to the embodiment of the present invention shown in FIG. 7, the lid 530 is also shaped to run the common cooling circuit 496. Thus the common cooling circuit 426 here passes through the first housing segment 422, through the second housing segment 424 and by the lid 530.

In a transitional area between the first housing segment 422 and the second housing segment 424, the passage segment 728 is arranged in the cooling circuit 426. The passage segment 728 is shaped here to allow passage of coolant from the common cooling circuit 426 between the first housing segment 422 and the second housing segment 424.

According to one embodiment, the housing 420 features a number of passage segments 728. The housing 420 in the second housing segment 424 may also feature at least one mounting device for attaching the power electronics unit.

FIG. 8 shows a flow diagram of a method 800 of manufacturing according to an embodiment of the present invention. The method 800 is carried out here for manufacturing to produce a drive unit for a vehicle. By carrying out the method 800 for manufacturing, a drive unit such as the drive unit from one of FIGS. 4 to 7 is advantageously produced.

Thus the method 800 for manufacturing in conjunction with a housing, can be carried out for a drive unit for a vehicle. The method 800 for manufacturing can be carried out here in conjunction with a housing such as the housing from one FIGS. 4 to 7. In other words, the method 800 for manufacturing in conjunction with a housing can be carried out, which features a first housing segment for accommodating an electric machine, and a second housing segment for accommodating a power electronics unit for the electric machine. The first housing segment and the second segment housing are in this case shaped in one piece. The first housing segment and second housing segment are shaped moreover to run a common cooling circuit for cooling the electric machine and power electronics unit.

The method 800 for manufacturing features an arrangement step 810 for arranging the electric machine in the first housing segment of the housing, and the power electronics unit in the second housing segment of the housing. The housing can be available prior to the arrangement step 810.

According to one embodiment, the method 800 for manufacturing also includes a sealing step 820 of the second housing segment using a lid. In the sealing step 820, the lid on the second housing segment is attached. In this way an interior space of the second housing segment is closed by the lid, and is in specific sealed off.

The embodiments described and shown in the figures are selected only by way of example. Different embodiments can be combined in their entirety or in relation to individual characteristics. An embodiment can also be complemented with characteristics of another embodiment. Procedural steps of the invention may furthermore be repeated and carried out in another order than that described.

Should one embodiment comprise an “and/or” association between a first characteristic and a second characteristic, then this can be read, such that the embodiment according to one embodiment either only the first characteristic or only the second characteristic is featured.

### REFERENCE NUMBER

100 Drive Unit
110 Machine Housing
120 Electronic Housing
120 Lid
310 Electric Machine
330 First Cooling Circuit
340 Second Cooling Circuit
400 Vehicle
405 Gear Mechanism
410 Drive Unit
412 Electric Machine
414 Power Electronics Unit
420 Housing
422 First Housing Segment
424 Second Housing Segment
426 Common Cooling Circuit
530 Lid
728 Passage Segment
800 Method of Manufacturing
810 Arrangement Step
820 Sealing Step

1. A housing for a drive unit for a vehicle, the housing comprising:
a first housing segment for accommodating an electric machine; and
a second housing segment for accommodating a power electronics unit for the electric machine;
wherein the first housing segment and the second housing segment are shaped in one piece; and
wherein the first housing segment and the second housing segment are shaped to run a common cooling circuit for cooling the electric motor and the power electronics unit.

2. The housing of claim 1, characterized by the housing further comprising at least one passage segment for passage of coolant of the common cooling circuit between the first housing segment and the second housing segment.

3. The housing of claim 1, wherein the housing further comprises at least one mounting device for attaching the power electronics unit in the second housing segment.

4. The housing of claim 1, wherein the second housing segment is formed in the shape of a cup.

5. The housing of claim 1, wherein the housing further comprises a lid, wherein the lid is configured to seal off the second housing segment.

6. The housing of claim 5, wherein the lid is configured to run a segment of the common cooling circuit.

7. A drive unit for a vehicle, the drive unit comprising:
an electric machine for the vehicle; and
a power electronics unit for the electric machine;
wherein the drive unit comprises the housing of claim 1;
wherein the electric machine is arranged in the first housing segment and the power electronics unit is arranged in the second housing segment.

8. A vehicle comprising: a gear mechanism and the drive unit of claim 7; wherein the drive unit is coupled to the gear mechanism.

9. A method for manufacturing a drive unit for a vehicle, the method comprising:
arranging an electric machine in a first housing segment of a housing for the drive unit; and
arranging a power electronics unit in a second housing segment of the housing for the drive unit;
wherein the first housing segment and the second housing segment are shaped in one piece; and
wherein the first housing segment and the second housing segment are shaped in order to run a common cooling circuit for cooling the electric machine and the power electronics unit.

10. The method of claim 9, wherein the method further comprising sealing the second housing segment with a lid.

11. The housing of claim 2, wherein the housing further comprises at least one mounting device for attaching the power electronics unit in the second housing segment.

12. The housing of claim 2, wherein the second housing segment is formed in the shape of a cup.

13. The housing of claim 3, wherein the second housing segment is formed in the shape of a cup.

14. The housing of claim 2, wherein the housing further comprises a lid, wherein the lid is configured to seal off the second housing segment.

15. The housing of claim 14, wherein the lid is configured to run a segment of the common cooling circuit.

16. The housing of claim 3, wherein the housing further comprises a lid, wherein the lid is configured to seal off the second housing segment.

17. The housing of claim 16, wherein the lid is configured to run a segment of the common cooling circuit.

18. The housing of claim 4, wherein the housing further comprises a lid, wherein the lid is configured to seal off the second housing segment.

19. The housing of claim 18, wherein the lid is configured to run a segment of the common cooling circuit.

20. The drive unit of claim 7, wherein the housing further comprises at least one passage segment for passage of coolant of the common cooling circuit between the first housing segment and the second housing segment.
